(19) United States
(12) Patent Application Publication
(10) Pub. No.: US 2015/0095861 A1
(43) Pub. Date: Apr. 2, 2015

(54) METHOD FOR PRODUCING A DPA-RESISTANT LOGIC CIRCUIT

(71) Applicant: SIEMENS AG ÖSTERREICH, Wien (AT)

(72) Inventors: Friedrich Eppensteiner, Spitz (AT); Majid Ghameshlu, Wien (AT); Herbert Taucher, Moedling (AT)

(73) Assignee: SIEMENS AG ÖSTERREICH, Wien (AT)

(21) Appl. No.: 14/396,500

(22) PCT Filed: Apr. 12, 2013
(86) PCT No.: PCT/EP2013/057651

§ 371 Date: Oct. 23, 2014

(30) Foreign Application Priority Data
Apr. 27, 2012 (DE) 10 2012 207 065.6

(51) Int. Cl. G06F 17/50

(52) U.S. Cl. CPC G06F 17/505; G06F 17/5054; G06F 2217/64; G06F 2217/78
USPC 716/103

(57) ABSTRACT

In an application-specific integrated circuit (ASIC), a description of the logic circuit is formulated in a hardware description language and then converted into a description of a corresponding physical circuit, i.e., into a netlist, using a conversion program, i.e., a synthesis tool. The description at least largely consisting of standard cells. During the conversion process, the standard cells which are used in the netlist are replaced with standard cell versions which have a correspondingly balanced power dissipation. Spying on a mode of operation of the circuit by analyzing a power consumption of the circuit is thus advantageously hindered or prevented, in particular in security-relevant circuits.

### CROSS REFERENCE TO RELATED APPLICATIONS

This application is the U.S. national stage of International Application No. PCT/EP2013/057651, filed Apr. 12, 2013 and claims the benefit thereof. The International Application claims the benefit of German Application No. 102012207065.6 filed on Apr. 27, 2012, both applications are incorporated by reference herein in their entirety.

### BACKGROUND

The method described below relates in general to the field of electronic and logic circuits, especially so-called application-specific integrated circuits (ASICs). Specifically the method relates to producing a logic circuit, especially an application-specific integrated circuit, which is constructed at least partly from standard elements or standard functions, so-called standard cells. In such cases a description of the logic circuit formulated in a hardware description language is converted by a conversion program into a description of a corresponding physical circuit, such as one at least largely consisting of so-called standard cells, into a so-called netlist.

Logic or electronic circuits, which are especially implemented as so-called integrated circuits, today form the basis for any type of electronics, especially in computer technology. Usually electronic circuits consist of electronic components accommodated on an individual substrate (e.g. semiconductor substrate, etc.) and wired to one another. An integrated circuit thus has a large number of different types of component as well as connecting line paths on or in a monocrystalline substrate. Only through this integration is it possible to make available comprehensive functionalities and applications in a small space. Through integrated circuits a plurality of applications (e.g. in mobile devices, SIM cards, RFIDs, mobile telephones, etc.) are able to be implemented for the first time, since these applications would otherwise be too expensive, too complex, too power-intensive or too large (e.g. for installation into the respective device, etc.).

If logic or integrated circuits are created for a specific application, the circuits are frequently referred to as application-specific integrated circuits or ASICs for short. ASICs are thus used in many different electronic devices—for example in a radio alarm or mobile radio devices through to high-power computers. One reason for the development of application-specific integrated circuits or ASICs, which are not able to be manipulated after their implementation is, above all with a high production volume, a cost saving compared to a discrete design of circuits. With digital ASICs in particular the respective integrated circuit can thus be designed for the respective application, which is then processed by this ASIC in e.g. a space-optimized, consumption-optimized, cost-optimized and/or power-optimized manner. The main difference from other logic circuits, such as e.g. Field Programmable Gate Arrays (FPGAs) or Programmable Logic Devices (PLDs), lies in the fact that with an ASIC the functionality of the integrated circuit is uniquely defined during production and can no longer be modified by a user. In such cases modern ASICs can comprise not just simple logic functions or logic gates, but also system blocks, memory blocks, processors, etc., in order to realize the desired functionalities or functions.

For the creation or for a design of an ASIC or an application-specific, integrated circuit usually a so-called hardware description language such as what is known as the Very High Speed Integrated Circuit Hardware Description Language (VHDL) or Verilog for example is used. The hardware description language in this case is a formal language with which operations of integrated circuits and also their design can be described. In the hardware description language a description is formulated of the respective logic circuit—i.e. timing sequences and/or (spatial) circuit structures for example.

From a description of a logic circuit or an ASIC created with the hardware description language, with the aid of a conversion program—a so-called synthesis tools—a description of the corresponding physical circuit or of the ASIC—a so-called netlist—is then generated. This process is also referred to as synthesis. In the synthesis, on the basis of the description formulated with the hardware description language, the respective predetermined functions for the logic circuit or the ASIC are assembled from preplanned elements or elements available from a catalog—the so-called standard cells, which can be made available for example in the form of libraries for the conversion program or synthesis tool. These standard cells can for example be designed specifically for the production process, wherein a layout of the respective standard cell already exists before the start of the circuit design. The result of the synthesis is then the description of a corresponding, physical circuit or of the ASIC—known as the netlist, which predominantly consists of the standard cells (e.g. logic gates, memory blocks, etc.). The netlist in the field of electronics or circuit design is usually a description of the connections between the standard cells contained in the circuit or in the ASIC respectively.

Logic circuits realized and implemented in this way, especially ASICs, have a strict dependence on the data to be processed. I.e. the logic implemented in the circuit is closely related to the function or functions to be executed and the data used and/or arising in such functions. With safety-relevant circuits/ASICs or with circuits/ASICs with embedded safety-critical systems this can represent a point for attacks. In such cases what are referred to as side-channel attacks are used in particular.

In a side channel attack functions and/or algorithms executed by a logic circuit are usually observed and an attempt is made to find correlations between the observed data and dependent, i.e. manipulated data (e.g. keys, encrypted data, etc.). This information is obtained for example from an analysis of the runtime of an algorithm, the energy consumption of the circuit during the execution of a function etc. In such cases methods such as a simple and/or differential power loss analysis are employed, for example.

In simple power loss analysis an energy consumption of a circuit or of an ASIC is recorded directly during safety-critical (e.g. cryptographic) functions for example. Since the energy consumption varies depending on the respective operations being executed in the circuit, conclusions can be drawn about the circuit structure of the ASIC, functions executed and safety-critical data. In differential power loss analysis the energy consumption of a circuit or of an ASIC is not only recorded but is also statically analyzed. In such an analysis measurement deviations during energy consumption are utilized to draw conclusions about safety-relevant functions and/or data. Differential power loss analysis is especially applied to circuits etc. in which disruptions occur that are too large for a simple power loss analysis. This enables power loss analyses above all to spy on secret and/or sensitive data such as keys etc. for example on the basis of an analysis of the energy consumption for functions executed in a circuit/ASIC.

In order to prevent such spying on functions and data based on the energy consumption of the circuit or of the ASIC, the option exists for example of applying random delays to processing cycles—i.e. a sequence of functions and/or operations during which sensitive data is being processed, by which conclusions can no longer be drawn from energy consumption about a function or data being processed. However this method of operation has the disadvantage of leading to a deterioration in the performance of the circuit or of the ASIC.

As an alternative specific cells can also be developed in so-called silicon technology for logic circuits or ASICs, in order to protect the circuit or the ASIC from the side channel attacks. However such cells are very specific and are therefore not available for a broad mass of ASIC technologies.

### SUMMARY

Described below is a method for creating logic circuits, especially application-specific integrated circuits or ASICs, through which in a simple manner and with low additional outlay a logic circuit can be produced which is protected from functions executed therein being derived by analysis of a power dissipation.

This method is of the type described at the start, in which, in a conversion of the description of the logic circuit formulated in a hardware description language into a so-called netlist by a conversion program, standard cells used in the netlist will be replaced by corresponding power-dissipation-balanced versions of the standard cells.

The main aspect of the method involves a circuit being created in a simple manner and with relatively low additional outlay or without any additional outlay, in which balancing of the power dissipation is achieved to a large extent. The power dissipation is thus made largely independent of the data to be processed. Furthermore a circuit is created by the method in which, by the power-dissipation-balanced standard cells, all basic operations (e.g. AND logic operations, OR logic operations, etc.) will be computed simultaneously. This occurs through the use of the power-dissipation-balanced standard cells independently of the function actually provided or required. Outputs of standard cells in the circuit that are not needed will have a so-called dummy load applied to them in such cases, so that no faults arise in the circuit. Through the use of the power-dissipation-balanced standard cells in a logic circuit or in an ASIC, success of side channel attacks, which are based on methods of power dissipation analysis, can be reduced very easily and efficiently for safety-relevant functions in this logic circuit and especially in this ASIC cell. The method also allows a simple realization of logic circuits or ASICs with standard design tools for diverse standard CMOS technologies.

It is advantageous for standard cells used in the netlist to be supplemented by the power-dissipation-balanced versions of the standard cells. In this case the standard cell is expanded such that an original function and a corresponding associated, inverted function at the output will always be made available by the power-dissipation-balanced version of this standard cell. Thus it is ensured in a simple manner according to a so-called dual-rail principle that in the standard cells used in the circuit or in the ASIC all basic operations are always computed simultaneously and thus from the power dissipation the actual function provided or required of the respective standard cell is no longer able to be derived from the energy consumption. In the conversion into a netlist of the description of the logic circuit created by the hardware description with the conversion program or synthesis tool, for each netlist or network of a logic circuit a netlist or network for the respective inverted functions is created and linked accordingly. Outputs not needed in such cases have a dummy load applied to them.

So-called logic gates are ideally used as standard cells. A logic gate, or gate for short, in the technical information or in the creation or description of a logic circuit, is the realization of a so-called Boolean function. Through a logic gate input signals are processed into output signals. The input signals in such cases are converted by implementation of logical operations such as e.g. AND, OR, NEGATION, NOT AND or NAND, NOT OR or NOR, XOR, etc. into a single logical result and mapped by the output signals. Through the method logic gates used in a circuit description are supplemented during the synthesis by the conversion program with the respective inverted operation or function into a dissipation-balanced version. This means that for example an AND gate will be expanded by a negative AND gate—a so-called NAND gate. For an OR gate the function is expanded by a so-called NOR gate and so on.

Frequently logic circuits or ASICs include memory blocks, especially so-called flip-flops, in addition to logic gates. Therefore memory blocks, especially flip-flops, are expediently also provided as standard cells for the creation of a logic circuit. Memory blocks such as e.g. flip-flops, which are also referred to as a bistable flip-flop stage or bistable flip-flop elements, are electrical circuits or elements by which two stable states can be assumed. Thus in a memory block or a flip-flop a quantity of data can be stored by one bit over a specific, predetermined period of time. Memory blocks are basic components of what are known as sequential circuits and thus an indispensable building block for building a logic or electronic circuit or an ASIC.

In a specific embodiment variant of the method, especially for memory blocks as standard cells, for a power-dissipation-balanced version of a memory block a first memory block is supplemented with a second memory block such that whenever the first memory block is switched, a respective state is retained by the second memory block and vice versa. This means if its state is retained by a memory block—e.g. the first—then the other, e.g. the second memory block toggles. In this simple way the total power dissipation of the power-dissipation-balanced version of the memory block is largely independent of the respective change of state. A change of state of the memory block (e.g. flip-flop) can thus no longer be derived from the overall power dissipation. Performance of the power-dissipation-balanced memory block however remains largely equal to performance of the original memory block.

This is also useful in the method for the power-dissipation-balanced versions of the standard cells to be stored or made available in one or possibly also a number of memories for the replacement of the standard cells in the netlist. In this way for example conversion programs or synthesis tools can be adapted or expanded quickly and at low cost. Standard cells such as e.g. logic gates, memory blocks, etc. will usually be designed for a fabrication process of logic circuits or ASICs and made available in accordance with a catalog in the form of libraries, for example, to the conversion program for conversion of the description of the circuits formulated in the hardware description language into a netlist. The storage of the power-dissipation-balanced versions of the standard cells enables the cells to be made available to the conversion program very easily and without any great effort. A power-dissipation-balanced version of a logic circuit or an ASIC can then be created without any great effort by the conversion program from the description of the respective circuit formulated in the hardware description language without account having had to be taken of this during the creation or designing of this circuit in the hardware description language.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram or flowchart of a typical sequence of the method for producing a logic circuit.

FIGS. 2a and 2b are examples logic circuit diagrams for replacing standard cells by respective dissipation-balanced versions.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

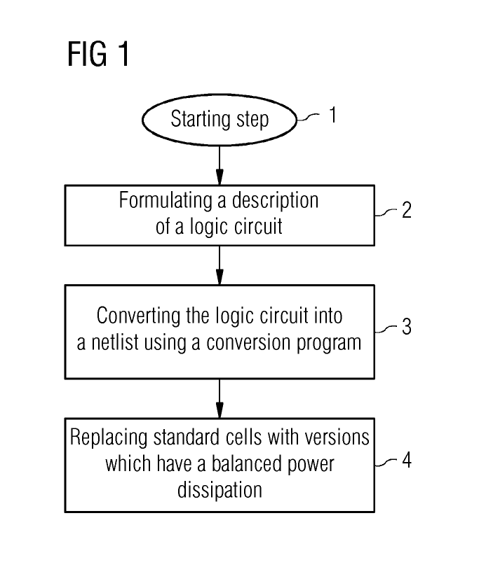

FIG. 1 shows a schematic diagram of a typical sequence of the method for creating a logic circuit. The method begins with 1. Then, in 2, a description of a logic circuit, especially of an application-specific integrated circuit or ASIC is formulated. For such a design or such a description of the logic circuit (ASIC) usually so-called hardware description languages such as VHDL, Verilog, etc. are used for example. In such cases operations, functions etc. which are to be executed by the circuit or by the ASIC are described by this description of the logic circuit. The description includes e.g. timing sequences, spatial circuit structures, etc. for the circuit.

From a description of a logic circuit or an ASIC formulated in the hardware description language, in 3 a description of a corresponding physical circuit is generated. The conversion of the description of the logic circuit into the description of the corresponding, physical circuit is carried out with the aid of a conversion program—a so-called synthesis tool. This process is also referred to as a synthesis and the result of the synthesis—i.e. the corresponding physical circuit description—is also referred to as a netlist.

In 3 or in the synthesis, the respective predetermined functions for the circuit or the ASIC are assembled on the basis of the description formulated with the hardware description language from pre-planned elements or elements available from a catalog—the so-called standard cells. The netlist, which at least in large part consists of such standard cells, such as e.g. logic gates, memory blocks, etc., usually describes connections between the standard cells used in the circuit or in the ASIC and thereby a structure of this circuit. The standard cells can be made available to the conversion program or the synthesis tool in the form of libraries, wherein the standard cells can be designed specifically for the respective fabrication process for example. This means that the respective standard cells are already available before the start of a circuit design for example.

In 4 the standard cells, which are used in the netlist generated in 3, are replaced by corresponding power-dissipation-balanced versions of these standard cells used in each case. In 4 can in this case for example be executed after 3. This means that for example first of all a netlist is generated from the description of the logic circuit, and then in this netlist the standard cells used are replaced by corresponding power-dissipation-balanced versions. In such cases for example a standard cell can be expanded such that a function, as well as an associated inverted function, are always made available by the power-dissipation-balanced version of the standard cell at the output of the standard cell. As an alternative the corresponding power-dissipation-balanced versions of the standard cells can also be made available in the form of one or more specific libraries.

As an alternative, 4 can be integrated, for example, into 3, i.e., during the creation of the netlist, instead of a specific standard cell, the corresponding power-dissipation-balanced version of this standard cell is always taken. In this variant too the power-dissipation-balanced versions of the standard cells can for example be made available to the conversion programs as a specific library or by expansion of the corresponding standard cells, i.e. function and inverted function are displayed at the output—can be used in the netlist.

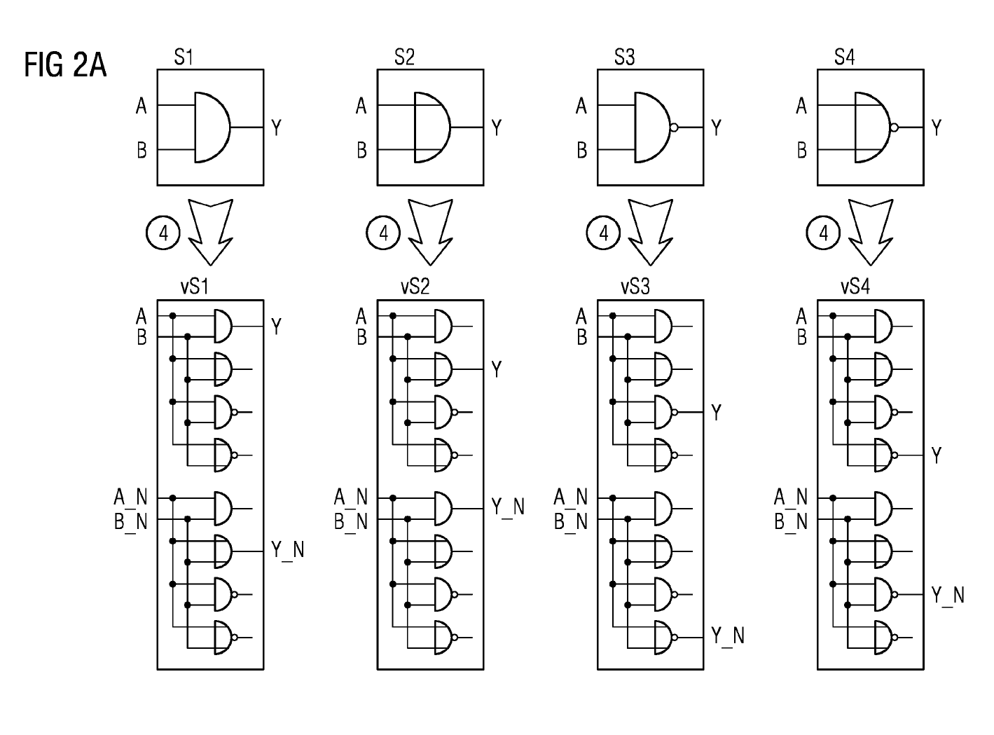

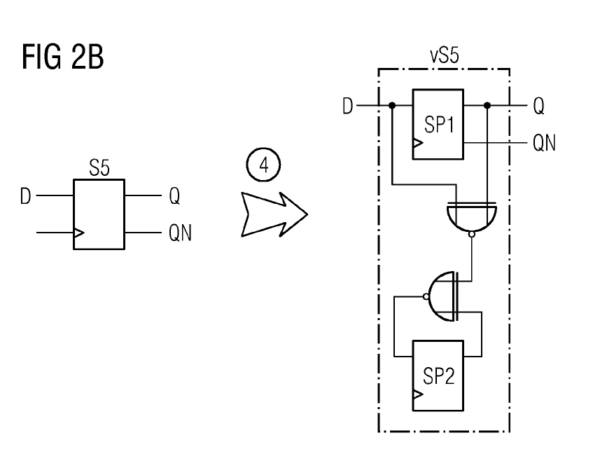

FIGS. 2a and 2b show schematic examples of standard cells S1 to S4 or S5 usual in netlists and also the corresponding power-dissipation-balanced versions vS1 to vS4 or vS5, wherein the power-dissipation-balanced version vS1 to vS4 or vS5 is always functionally equivalent to the corresponding standard cell.

FIG. 2a here shows the typical standard cells S1, S2, S3 and S4. The standard cells S1 to S4 are so-called logic gates which represent a realization of so-called Boolean functions, and from which input signals A, B are processed to form an output signal Y.

A first example standard cell S1 is used for a realization of a logical AND function—i.e. the input signals A, B will be logically linked by a so-called AND function to form an output signal Y. In 4, the first standard cell S1 is replaced by a corresponding power-dissipation-balanced version vS1 of the standard cell S1. The first power-dissipation-balanced version vS1 of the standard cell S1 is characterized by the fact that all basic operations can be simultaneously computed by it—regardless of the actually required function. The first power-dissipation-balanced version vS1 an upper part and a lower part.

In the upper part for example four logic gates, which for example represent four logical basic functions (AND, OR, NAND, NOR) are networked or switched such that the signals A, B will be logically linked into an AND function and an output signal Y—i.e. the output signal Y only has a value 1 for example if both input signals likewise have the values 1. In the lower part, which likewise includes, e.g., four logic gates for the four basic logic functions (AND, OR, NAND, NOR), like the upper part, the four logic gates are connected so that for negated input signals A_N, B_N at the output the inverted function or an inverted output signal Y_N to the output signal Y of the upper part will be made available. The remaining outputs of the first power-dissipation-balanced version vS1, which are not needed, have a so-called dummy load applied to them. Thus the function or the output signal Y and the inverted function or the inverted output signal Y_N is always made available at the output according to the dual principle by the first power-dissipation-balanced version vS1 of the first standard cell and then linked accordingly into the netlist.

A second standard cell S2 shown by way of example in FIG. 2a is used for realization of the logical OR function, in which input signals A, B are logically linked via an OR operation to form output signal Y. With an OR function the output signal Y then has the value 1 if at least one of the two input signals A, B have the value 1. In 4, the OR function is expanded or replaced such that in the netlist a second power-dissipation-balanced version vS2 of the second standard cell S2 is used. This second power-dissipation-balanced version vS2 of the second standard cell S2 likewise has an upper part and a lower part, each of which uses the four basic logic functions (AND, OR, NAND, NOR). The upper part, however, is designed so that the input signals A, B are logically linked via the OR function to form output signal Y. In the lower part the negated input signals A_N, B_N are logically linked such that the inverted function or the inverted output signal Y_N is made available at the output.

Furthermore in FIG. 2a, in a third standard cell S3 for example a NOT AND or NAND function and in a fourth standard cell S4 a NOT OR or NOR function are shown. With the NAND function the output signal Y only produces a value 0 if both input signals A, B have the value 1. If a least one of the input signals A, B has the value 0, then the value 1 will be output as output signal Y. With the NOR function the output signal Y only has the value 1 if both input signals A, B have the value 0. If the value of a least one input signal A, B is 1, then the output signal Y of the function at the output has the value 0. Through 4 the standard cells S3, S4 are replaced by a corresponding third or fourth power-dissipation-balanced version vS3, vS4 of the respective third or fourth standard cell S3, S4 in the netlist.

These power-dissipation-balanced versions vS3, vS4 of the third or fourth standard cell S3, S4 also has an upper part and a lower part formed from the four basic logic functions (AND, OR, NAND, NOR). In this case, for the third power-dissipation-balanced version vS3 of the third standard cell S3 the NAND function is networked in the upper part and in the lower part the negated input signals A_N, B_N are logically linked so that at the output the inverted function or the inverted output signal Y_N for the NAND function is made available. With the fourth power-dissipation-balanced version vS4 of the fourth standard cell S4 a NOR function is represented in the upper part. Through the lower part the negated input signals A_N, B_N are networked such that the inverted function of the inverted output signal Y_N for the NOR function is output at the output. Outputs not needed have a so-called dummy load applied to them for example in order to prevent faults etc. for example.

FIG. 2b shows a schematic example of a fifth standard cell S5. The fifth standard cell S5 is an example memory block S5, which is implemented e.g. as a flip-flop. Such a memory block S5 or flip-flop S5 is an electronic circuit by which two stable states can be assumed and by which a quantity of data can thus be stored by one bit. The memory block S5 shown by way of a schematic example is e.g. a so-called D flip-flop or delay flip-flop, through which a data signal can be delayed by one clock. The memory block S5 has a data input D and a clock input, as well is an output Q and an associated inverted output QN. Through the memory block S5 or the D flip-flop S5, with an enabled clock input or active clock edge, a logical state present at the input D is stored and consequently its value is output at output Q. If there is no active clock edge present or if the clock input is deactivated, the input value D is not accepted.

In 4, a power-dissipation-balanced version vS5 of the memory block S5 is introduced or the standard memory block S5 is replaced by this version vS5 in the netlist. In the power-dissipation-balanced version vS5 of the memory block S5 or the flip-flop S5 a first memory block SP1 or a first flip-flop SP1 is supplemented by a second memory block SP2 or second flip-flop SP2. In this way for example, for flip-flop S5 the first D flip-flop SP1 is expanded with a second D flip-flop. Data input D and output Q of the first memory block SP1 or first flip-flop SP1 are logically linked to one another for example via a first logic gate and then after a logic operation with an output of the second memory block SP2 or flip-flop SP2, form a data input of the second memory block SP2 or flip flop SP2. Overall the power-dissipation-balanced version vS5 of the memory block S5 has a data input D as well is an output Q and an associated inverted output QN for networking in the netlist. However the power dissipation of the power-dissipation-balanced version vS5 of the memory block S5 is largely independent of a state change, since for example a second flip-flop SP2 toggles if a state is maintained by the first flip-flop SP1 and vice versa. Thus so-called side channel attacks are rendered significantly more difficult.

Such power-dissipation-balanced versions can also be created for a further memory blocks or flip-flop such as e.g. T flip-flops or toggle flip-flops, etc.

Through the method standard cells S1, S2, . . . , S5 such as e.g. logic gates, memory blocks, etc. can be replaced in a netlist by corresponding power-dissipation-balanced versions vS1, vS2, vS5 of the standard cells S1, S2 . . . , S5 or expanded into the versions. This enables the success of so-called side channel attacks on a logic circuit or an ASIC to be significantly reduced.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A method for creating a logic circuit, comprising:
converting a description of the logic circuit formulated in a hardware description language by a conversion program into a netlist containing a description of a corresponding physical circuit containing at least standard cells; and
replacing the standard cells in the netlist by corresponding power-dissipation-balanced versions of the standard cells.

8. The method as claimed in claim 7, further comprising expanding the standard cells used in the netlist for the power-dissipation-balanced versions of the standard cells by including an original function and a corresponding associated inverted function in a power-dissipation-balanced version of each standard cell.

9. The method as claimed in claim 8, wherein the standard cells are logic gates.

10. The method as claimed in claim 8, wherein the standard cells are memory blocks.

11. The method as claimed in claim 10, wherein the power-dissipation-balanced version of each memory block includes a first memory block supplemented with a second memory block that retains a state of the first memory block when the first memory block is switched.

12. The method as claimed in claim 11, further comprising storing the power-dissipation-balanced versions of the standard cells in a special library accessed by said replacing the standard cells in the netlist.

13. The method as claimed in claim 10, further comprising storing the power-dissipation-balanced versions of the standard cells in a special library accessed by said replacing the standard cells in the netlist.

14. The method as claimed in claim 10, wherein the memory blocks are flip-flops.

15. The method as claimed in claim 9, further comprising storing the power-dissipation-balanced versions of the standard cells in a special library accessed by said replacing the standard cells in the netlist.

16. The method as claimed in claim 8, further comprising storing the power-dissipation-balanced versions of the standard cells in a special library accessed by said replacing the standard cells in the netlist.

17. The method as claimed in claim 7, wherein the standard cells are logic gates.

18. The method as claimed in claim 7, wherein the standard cells are memory blocks.

19. The method as claimed in claim 18, wherein the power-dissipation-balanced version of each memory block includes a first memory block supplemented with a second memory block that retains a state of the first memory block when the first memory block is switched

20. The method as claimed in claim 18, further comprising storing the power-dissipation-balanced versions of the standard cells in a special library accessed by said replacing the standard cells in the netlist.

21. The method as claimed in claim 18, wherein the memory blocks are flip-flops.

22. The method as claimed in claim 17, further comprising storing the power-dissipation-balanced versions of the standard cells in a special library accessed by said replacing the standard cells in the netlist.

23. The method as claimed in claim 7, further comprising storing the power-dissipation-balanced versions of the standard cells in a special library accessed by said replacing the standard cells in the netlist.

24. The method as claimed in claim 7, wherein the logic circuit is an application-specific integrated circuit.
